(19) United States
(12) Patent Application Publication
(10) Pub. No.: US 2007/0260464 A1
(43) Pub. Date: Nov. 8, 2007

(54) Method for the destruction of tangible media bearing sensitive information

(76) Inventors: Keith S. DiMarino, Thorofare, NJ (US); Andrew Kent Jan, Staten Island, NY (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/323,851

(22) Filed: Dec. 30, 2005

(51) Int. Cl. G06Q 10/00; G06Q 30/00

(52) U.S. Cl. 705/1

(57) ABSTRACT

A method for the destruction of tangible media bearing sensitive information via a third party service that is secure, cost effective and enhances the ease with which small companies; families, individuals and households dispose of sensitive material. Customers use sealable enclosures ordered online, or obtained at a retail location or place of business in order to place sensitive information within for destruction. The business may have a pre-existing relationship with the customer and may have both a fiduciary and a legal/financial interest in having the customer's sensitive information destroyed. Both the customer and the business are able to track and confirm the destruction of the tangible media that bears the sensitive information.

### BACKGROUND OF THE INVENTION

1. Field of the Invention

The invention relates to the field of sensitive information destruction. In particular the invention relates to a method for securing and destroying tangible media that bears sensitive information.

2. Description of the Related Technology

The shredding industry has witnessed rapid growth over the past 10 years in response to the fastest growing crime in the United States, identity theft. In 2004, this crime cost banks and financial institutions $48 billion and its victims $5 billion. Millions of Americans have been victims of identity theft. As a result the government has implemented several privacy laws that are intended to decrease the frequency of thefts and implement severe fines for those who do not properly handle private information. These laws refer specifically to the disposal of confidential information and indicate that businesses and individuals who have access to this information must “burn, pulverize or shred” confidential materials.

Most medium and large companies have hired private firms to dispose of and destroy their confidential documents. However, small companies, families, individuals and households are still struggling to properly dispose of their documents in an affordable and efficient way. Furthermore, whether or not small companies, families, individuals and households dispose of their confidential documents in a proper fashion has become of increasing concern to those institutions that interact with these people in a financial manner.

Companies in the document destruction industry often seek certification by the National Association for Information Destruction (NAID), which is the leading international trade association for companies providing information destruction services. The NAID industry standard for destruction of paper or printed media is a shred width of no greater than ⅝ inch for a continuous shred, and particle sizes of no larger than ¾ inches by 2.5 inches for a cross-cut shred. For the destruction of micro media, NAID specifies a maximum particle size of no greater than ⅛ inch maximum dimension. These are considered to be the industry standards for destruction of information bearing media.

There have been a number of companies that have attempted to facilitate the destruction of secure information. Some companies specialize in picking up the material to be destroyed; however this can be a costly service. One company permits people to ship a box to be destroyed, however this too can be costly and time consuming. Another company has established various drop boxes wherein a person may drop off those materials that are needed to be destroyed. However, the establishment of the infrastructure necessary to have a sufficient number of drop boxes is costly.

Therefore there remains a need in the field to provide a method for the destruction of sensitive information via third party handlers that remains cost effective and enhances the ease with which small companies; families, individuals and households dispose of sensitive information.

### SUMMARY OF THE INVENTION

Accordingly, it is an object of certain embodiments of the invention to provide a method for the destruction of sensitive information via third party handlers that remains cost effective and enhances the ease with which small companies, families, individuals and households dispose of sensitive information.

According to a first aspect of the invention, a method of securing sensitive information that is disseminated on tangible media by an interested entity includes steps of disseminating to a recipient party tangible media bearing sensitive information; providing to the recipient party a transmitting structure for transmitting tangible media; transmitting the tangible media using the transmitting structure, wherein the step of transmitting said tangible media is performed so that the transmission of said tangible medium is tracked; and destroying said tangible media with a destruction facility.

According to a second aspect of the invention, a method for destroying tangible media that may bear sensitive information includes steps of providing to a recipient party a sealable enclosure for transmitting tangible media that may bear sensitive information; transmitting the tangible media using the sealable enclosure, wherein the step of transmitting the tangible media is performed so that the transmission of said tangible medium is tracked; destruction of the tangible media by a destruction facility; and recording percipient evidence of the destruction of the tangible media, the percipient evidence comprising a percipient verification of the presence of the enclosure at the destruction facility.

According to a third aspect of the invention, method for destroying tangible media that may bear sensitive information includes steps of receiving within a destruction facility a sealed individually identifiable enclosure containing tangible media that bears sensitive information; individually identifying and recording percipient evidence of the presence of the sealed enclosure in the proximity of a destruction mechanism; destroying the enclosure and the tangible media therein; and making said evidence of destruction available to an interested party.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a diagram showing an overview of the method for destruction of sensitive information.

FIG. 2 shows a diagram showing a more detailed example of the ordering process.

FIG. 3 shows a diagram showing a more detailed example of the destruction process.

FIG. 4 shows a diagram of the method for profiling potential customers of sensitive information destruction services.

### DETAILED DESCRIPTION OF THE PREFERRED EMBODIMENT(S)

The instant invention in its preferred embodiment includes a method and system that utilizes a transmission structure such as a secure destruction sealable enclosure or packet, similar to a FedEx® envelope, or other courier service type envelope, to securely transport tangible media bearing sensitive information, such as confidential documents for shredding, to a destruction facility. Such courier enclosures typically have identifying indicia either printed directly thereon or on a label that is affixed thereto, such as a tracking number that can be used by the courier service, its customers, deliveries and others to keep track of the location of a particular package.

It is intended that interested entities such as businesses, governmental entities, nonprofit institutions, military institutions and international agencies and non-governmental organizations that suffer from the losses incurred from identity theft and other misappropriation of confidential information will be interested in promoting the usage of the sensitive information destruction service. Businesses, such as financial institutions, can promote the use of the secure destruction packet to their customers. Customers of these businesses may enter the business's branch location and pick up an empty secure destruction packet, and then return to their home or office to fill the packet with confidential documents that they want to have destroyed. Alternatively, they may visit the business's website and order a label, or print a label from the website. Once they have the label they can attach it to a packet they want to have destroyed and then fill the packet with secure information. Once the packet is full, the customer deposits it into any “drop off box” nationwide. The secure destruction packet barcode is then scanned, the packet destroyed and the shredded material that is recyclable is then recycled. The system and method are discussed in further detail below.

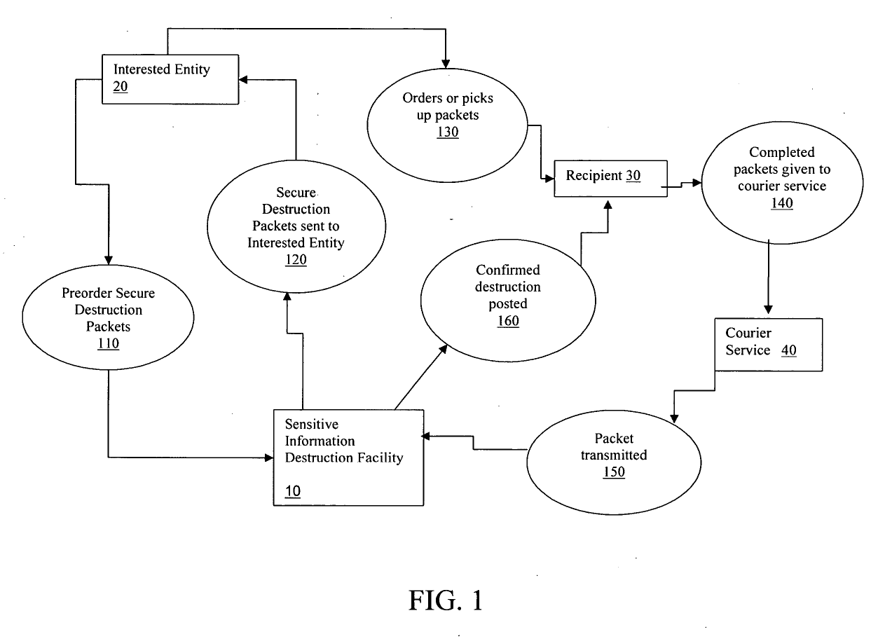

FIG. 1 shows an overview of the process involved. FIG. 1 shows the four main players in the method; tangible media destruction facility 10, interested entity 20, recipient party 30, and courier service 40.

Tangible media destruction facility 10 is a facility that is capable of destroying packets of secure information. Facility 10 may have the capacity to accomplish large amounts of document shredding, burning, and/or pulverization. Additionally facility 10 may have the capacity to demolish additional materials that may contain sensitive information, such as the hard drives that are typically used on computers.

Interested entity 20 is typically any entity that is concerned with the destruction of its contact's or customer's sensitive information. Typically these may be financial institutions, such as banks, investment companies, and lending institutions. Additionally law firms, healthcare organizations, and other businesses or governmental entities that handle a customer's sensitive information may be interested in promoting the destruction of their customer's sensitive information, as well as being concerned for the destruction themselves.

Recipient party 30 is typically any person or other entity that conducts an interaction with interested entity 20. In general recipient party 30 may be a company, a family, an individual or a household.

Courier service 40 may be any organization that transports packages, boxes, envelopes, or any other material. In the preferred embodiment of the instant invention courier service 40 is a common carrier such as Federal Express®. By using a well-established courier service facility 10 can take advantage of a preexisting network of drop boxes where secure destruction packets may be dropped off.

In step 110 of the preferred embodiment, interested entity 20 preorders secure destruction packets from facility 10. At step 120, facility 10 sends the secure destruction packets requested from interested entity 20 preaddressed and with tracking details to interested entity 20. Tracking details may be contained in a barcode. Facility 10 can send the secure destruction packets to an interested entity via commercial shipping methods. They can be sent to a single repository or provided via the retail network of interested entity 20. When packets are sent via the retail network they may be sent without information related to recipient party 30. This will permit any recipient party 30, who may be a customer of the interested entity 20, to purchase packets at a retail location of the interested entity 20. Facility 10 has a database that is able to link information related to the secure destruction packets to interested entity 20 for billing and confirmation purposes.

At step 130, recipient party 30 orders secure information packets from the interested entity 20. This may be accomplished via a website or some other means. Interested entity 20 will distribute the secure information packets as per standard retail means such as, online, call center, storefront/branch. Interested entity 20, or facility 10, may bill recipient party 30 as per standard retail payment processes. Alternatively, interested entity 20 may cover a portion or all of the costs of providing one or more secure information packets in order to promote responsible destruction of sensitive information. It is also possible for both recipient party 30 and interested entity 20 to share the costs of the secure information packets, or for interested entity 20 to enter into a consortium with other concerned interested entities in order to cover expenses. Both interested entity 20 and recipient party 30 may take note of the respective tracking details that are associated with that secure information packet.

At step 140, recipient party 30 will transmit the filled secure information packet to courier service 40. At step 150, courier service 40 will transmit the packet to facility 10. Using the tracking information that is provided on the packet permits holders of the tracking information to keep track of the delivery of the packet to facility 10. Facility 10 will track receipt of the packet against a database of information that corresponds to the preprinted secure information packets. Facility 10 will destroy the packet and send confirmation of the tracking number to interested entity 20 as well as an invoice for services. At step 160 confirmed destruction is posted for a recipient party 30 to verify. This posted information may be at a website handled by facility 10, or may be relayed by interested entity 20, or both.

According to one important aspect of the invention, percipient evidence of the destruction of the secure packet containing the tangible media bearing the sensitive information is recorded at the facility 10 in order to verify the destruction of that tangible media. Preferably, this percipient evidence includes an image of the secure packet including visible indicia on the packet that clearly identifies the packet as being the same packet that contains the tangible media that was placed in the packet by the recipient party 30. In the preferred embodiment, this indicia includes the tracking number of the courier service that is used to transport the secure packet. It is possible to provide video confirmation of the destruction of the packet in order to further confirm destruction of packets. This video information may be posted at a website for access by either recipient party 30 or interested entity 20. Preferably, the video information includes the approach of the enclosure to the throat of the shredder and the actual destruction of the enclosure by the shredder, which requires a video camera to be placed in close proximity to the throat of the shredder.

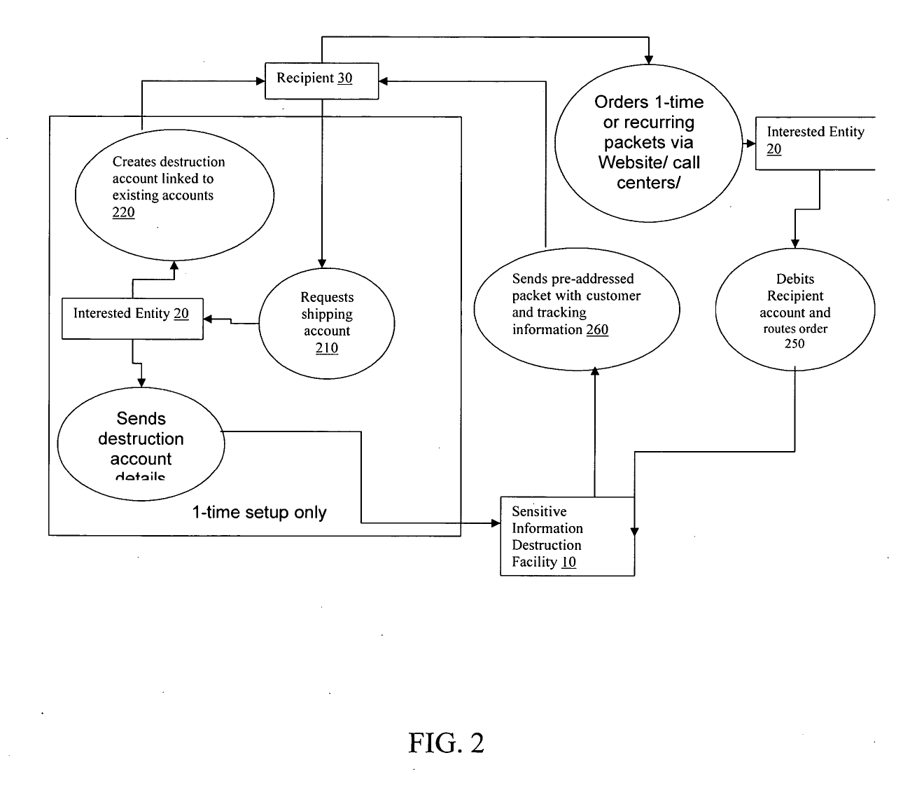

FIG. 2 shows a diagram showing a more detailed example of the ordering process. At step 210, as part of a one-time set-up, recipient party 30 will request a destruction account or alternatively may be automatically given one by interested entity 20. At step 220 the account is linked to existing accounts at interested entity 20. For financial institutions this account is similar to opening an existing account for deposit accounts. Additionally, these accounts will be linked to existing deposit accounts for purposes of payment for document destruction. For retail clients, this account will be tied to a customer account (i.e., customer information and payment details).

At step 230, interested entity 20 provides facility 10 with customer information that will be placed into databases for purposes of tracking and confirming destruction of physical records for both interested entity 20 and recipient party 30. Additionally, information sent to the databases can be used to determine which recipient parties 30 will be most likely to desire to utilize services for the destruction of sensitive information Payment details may be handled by interested entity 20 or alternatively by facility 10, depending upon the needs of interested entity 20.

At step 240, recipient party 30 orders a one-time transmission of secure destruction packets from interested entity 20, or sets up a reoccurring transmission of packets. These packets can be either ordered directly through interested entity 20 or through facility 10. Alternatively, interested entity 20 may request recipient party 30 to destroy sensitive information that it receives via the mail and subsequently transmit packets to recipient party 30 for them to use upon destruction of their sensitive information. It may also be possible for packets to be sold or provided at interested entity 20, whether interested entity 20 is a bank or a retail organization.

At step 250, orders from recipient party 30 routed through interested entity 20 will then be routed through to facility 10. Accounts of recipient party 30 will be debited. Bank customers with accounts linked to deposit accounts will have automatic debits, retail customers can go through existing payment processes. Alternatively, facility 10 can process payments upon request or transmit invoices directly to interested entity 20. Since facility 10 already has customer data on record, it can process and ship packets through to interested entity 20, or at step 260 transmit the packet directly to recipient party 30.

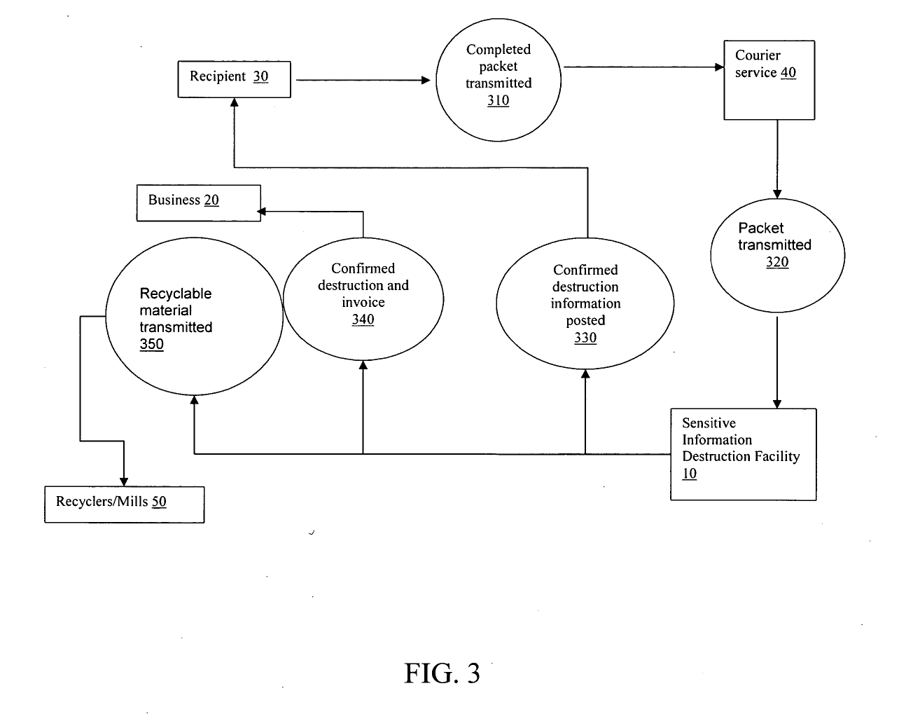

FIG. 3 shows a diagram showing a more detailed example of the destruction process. At step 310, recipient party 30 will complete a packet for drop off with a courier service 40. Ideally courier service 40 has a variety of locations for dropping off a packet. When packets are dropped off at pre-existing drop off boxes utilized by courier service 40 packets will be picked up in a routine fashion. In alternative embodiments it is possible that facility 10 can provide its own courier service, or utilize a variety of courier services. Interested entity 20 may also provide its own drop off boxes. For alternative drop boxes facility 10 may request courier service 40 to pick up the packets.

At step 320, courier service 40 will transmit the packet to facility 10. Upon receipt, packets are scanned and compared to information present in the database in order track receipt. The packet can be noted as received and is trackable online by recipient party 30 and interested entity 20. Non-valid packets are not processed. The package is shredded using industrial standard shredding equipment, or alternatively may be pulverized or burned.

The destruction is performed at minimal standards set forth by the NAID industry standards for the destruction of paper or printed media, which is a shred width of no greater than ⅝ inch for a continuous shred, and particle sizes of no larger than ¾ inches by 2.5 inches for a cross-cut shred. For the destruction of micro media, destruction is performed at minimal NAID specifications, namely a maximum particle size of no greater than ⅛ inch maximum dimension. These are considered to be the industry standards for destruction of information bearing media.

Destroyed packets are tracked as destroyed and are trackable by interested entity 20 and recipient party 30. At step 330, confirmation of destruction is sent to customer 30. At step 340, confirmation of destruction and an invoice is sent to interested entity 20. At step 350, recyclable material is transmitted to recyclers/mills 50.

It is also possible that interested entity 20 may use tracked packet information in order to provide in-house security for sensitive issues. Providing the tracked information to interested entity 20 will permit a chain of custody to be established for determination of proper destruction of material.

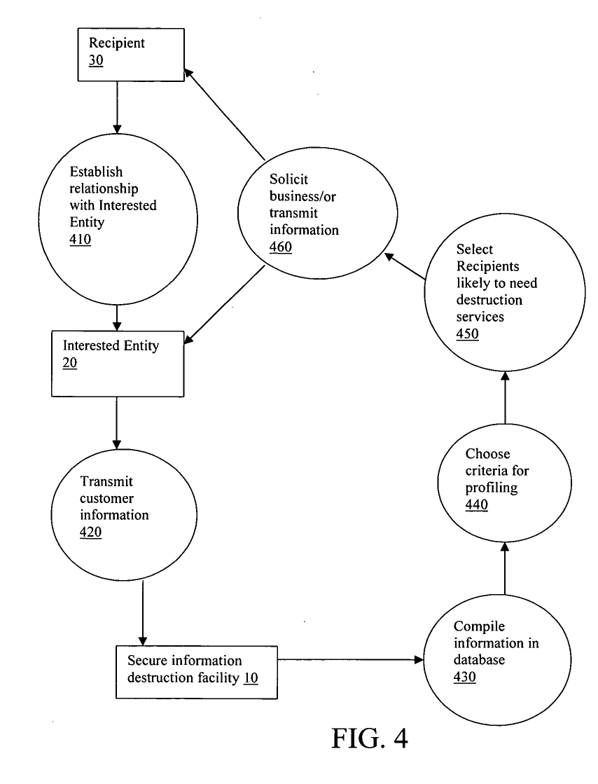

FIG. 4 shows a diagram of the method for profiling potential customers of sensitive information destruction services, i.e. those customers prone to be victims of identity theft. At step 410, recipient party 30 establishes a relationship with interested entity 20. At step 420, interested entity 20 transmits customer information to secure information destruction facility 10. Facility 10 uses this information in order to compile a database of potential customers who would need sensitive information destruction services.

At step 430, this information is compiled into a database. Facility 10 will compile information gathered from multiple businesses into the databases. At step 440, customer criteria indicative of a need for destruction of sensitive information are selected. These criteria may be information such as, good credit (e.g. credit score), holding certain accounts, amount of assets, usage of destruction services in the past, region, income, age, education, job, marital status, dwelling type, salary deposit type, number of financial accounts, value of deposit accounts, number of credit cards, activity of credit cards, sex, online banking usage, ATM usage, volume of paper statements, level of travel, etc. The criteria may be weighted based upon their respective importance in determining whether or not a customer would utilize the service. In choosing criteria a numerical value may be assigned to each specific piece of information. For example the holding of a certain number of accounts may generate a number based upon the type of account. This number can then be weighted when performing the selection process based upon the overall importance of accounts in determining whether or not a customer needs the service.

At step 450, an algorithm may be run to generate a score based on the criteria used for selection. At step 460, facility 10 may use this score, or the identified recipient party or customer 30 in order to solicit customer 30 to purchase and/or order secure destruction packets. Facility 10 may also develop lists of customers who need the destruction of sensitive information. This information may also be provided to interested entity 20 in order for them to evaluate the recipient party or customer 30 and/or order secure destruction packets for the recipient party or customer 30. This information may also be used in order to evaluate the diligence of the recipient party or customer 30 in the destruction of potentially harmful sensitive information. This type of information can then be used to evaluate the relationship between the interested entity 20 and the recipient party 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of securing sensitive information that is disseminated on tangible media by an interested entity, comprising steps of:
disseminating to a recipient party tangible media bearing sensitive information;
providing to the recipient party a transmitting means for transmitting tangible media;
transmitting said tangible media using said transmitting means, wherein the step of transmitting said tangible media is performed so that the transmission of said tangible medium is tracked; and
destroying said tangible media with a destruction facility.

2. A method of securing sensitive information according to claim 1, wherein said interested entity contributes to the expense of providing said transmitting means to the recipient party.

3. A method of securing sensitive information according to claim 1, wherein said transmitting means comprises a sealable enclosure and wherein said step of transmitting said tangible media comprises using a courier service.

4. A method of securing sensitive information according to claim 3, wherein said interested party contributes to the expense of said courier service.

5. A method of securing sensitive information according to claim 1, wherein said interested entity provides said recipient party with said transmitting means.

6. A method of securing sensitive information according to claim 1, further comprising recording a percipient verification of destruction of said tangible media.

7. A method of securing sensitive information according to claim 6, further comprising making available said percipient verification of destruction of said tangible media to at least one of said interested party and said recipient party.

8. The method of claim 7, wherein said step of making available said percipient verification of destruction of said tangible media includes providing a link to a web site.

9. The method of claim 6, wherein said percipient verification comprises an image evidencing the destruction of said tangible media.

10. The method of claim 9, wherein said transmitting means comprises a courier enclosure having visible identifying indicia, and wherein said image includes said identifying indicia.

11. The method of claim 6, wherein said percipient verification comprises a video evidencing the destruction of said tangible media.

12. The method of claim 1, further comprising the step of said interested party establishing a database comprising a list of said recipient parties.

13. The method of claim 12, further comprising the step of providing input to said database from said destruction facility.

14. A method for destroying tangible media that may bear sensitive information, comprising:
providing to a recipient party a sealable enclosure for transmitting tangible media that may bear sensitive information;
transmitting said tangible media using said sealable enclosure, wherein the step of transmitting said tangible media is performed so that the transmission of said tangible medium is tracked;
destruction of said tangible media by a destruction facility; and
recording percipient evidence of the destruction of said tangible media, said percipient evidence comprising a percipient verification of the presence of said enclosure at said destruction facility.

15. A method of securing sensitive information according to claim 14, further comprising making available said percipient verification of destruction of said tangible media to at least one of said interested party and said recipient party.

16. The method of claim 15, wherein said step of making available said percipient verification of destruction of said tangible media includes providing a link to a web site.

17. The method of claim 14, wherein said percipient verification of the presence of said enclosure at said destruction facility comprises an image evidencing the destruction of said tangible media.

18. The method of claim 17, wherein said sealable enclosure comprises a courier enclosure having visible identifying indicia, and wherein said image includes said identifying indicia.

19. The method of claim 14, wherein said percipient verification comprises a video evidencing the destruction of said tangible media.

20. The method of claim 14, wherein said percipient evidence comprises an image of said sealable enclosure positioned proximate to a locus of destruction within said destruction facility.

21. The method of claim 20, wherein said sealable enclosure has visible identifying indicia, and wherein said image includes said identifying indicia.

22. A method for destroying tangible media that may bear sensitive information, comprising:
receiving by a destruction facility a sealed individually identifiable enclosure containing tangible media that bears sensitive information;
individually identifying and recording percipient evidence of the presence of said sealed enclosure in the proximity of a destruction mechanism;
destroying said enclosure and the tangible media therein; and
making said evidence of destruction available to an interested party.

23. A method according to claim 22, wherein said interested party is a party that has a business interest in preventing misuse of said sensitive information.

24. A method according to claim 23, wherein said interested party is a financial institution.

25. A method according to claim 22, wherein said interested party is a consumer.

26. The method of claim 22, wherein said percipient verification of the presence of said sealed enclosure in the proximity of a destruction mechanism comprises an image evidencing the destruction of said tangible media.

27. The method of claim 26, wherein said sealed enclosure comprises a courier enclosure having visible identifying indicia, and wherein said image includes said identifying indicia.

28. The method of claim 22, wherein said percipient evidence comprises a video evidencing the destruction of said tangible media.
